(19) United States
(12) Patent Application Publication
(10) Pub. No.: US 2016/0301142 A1
(43) Pub. Date: Oct. 13, 2016

(54) ANTENNA STRUCTURE

(71) Applicant: NATIONAL TAIWAN UNIVERSITY, TAIPEI 10617 (TW)

(72) Inventors: TZONG-LIN WU, TAIPEI 10617 (TW); JUI-HUNG CHOU, TAIPEI 10617 (TW); JO-FAN CHANG, TAIPEI 10617 (TW); DING-BING LIN, NEW TAIPEI CITY 235 (TW)

(21) Appl. No.: 14/681,440

(22) Filed: Apr. 8, 2015

(51) Int. Cl. H01Q 13/16; H01Q 13/10

(52) U.S. Cl. CPC H01Q 13/16; H01Q 13/106

(57) ABSTRACT

The present invention provides an antenna structure, using a metal radiation plate having at least one bending slot and a metal grounding plate, where a starting end of the metal radiation plate is located on an edge of the metal radiation plate. A feed plate and a connecting grounding plate are separately connected to two sides of a starting end of the slot, and two ends of the connecting grounding plate may be separately connected to the metal radiation plate and the metal grounding plate. The feed plate may be connected to a core wire of a coaxial cable, and a peripheral conductor of the coaxial cable is connected to the metal grounding plate, so that different resonant modes can be controlled. The antenna can achieve a broadband effect, thereby solving the problem of the metal shielding effect in a wireless communication product using a full-metal back cover.

### BACKGROUND

1. Technical Field

The present invention relates to an antenna structure, and in particular, to an antenna structure applied to a wireless communication product with a full-metal back cover.

2. Related Art

A conventional wireless communication product often requires the design of a full-metal back cover, so as to support structural strength, show the metallic texture, and improve appearance. Based on the consideration of the appearance of a product, most antennas are designed to be built-in. However, due to the effect of the design of a full-metal back cover, the radiation feature of an antenna is often affected by the metal shielding effect, which results in low bandwidth and radiation efficiency or even a dead angle during signal transmission. In order to solve the problem in the radiation feature of an antenna during transmission, a conventional structure requires cutting a section of metal from the full-metal back cover and filling the section with a nonmetal material, so as to reduce the metal shielding effect and improve the radiation feature of an antenna. However, this method greatly affects the appearance of a product.

### SUMMARY

In order to solve the foregoing problem, the present invention provides a built-in antenna structure, which still has good bandwidth and antenna efficiency when being applied in a wireless communication product with a full-metal back cover that is not cut. In this way, the problem of insufficient bandwidth and poor radiation performance of a conventional antenna due to the full-metal back cover is solved, and lightness and good appearance of a product are also ensured.

In order to achieve the foregoing objective, the present invention provides an antenna structure, including: a metal radiation plate, having a slot and a starting end, where the starting end is located on an edge of the metal radiation plate, the slot extending laterally has a first slot part and a second slot part, two ends of the first slot part are defined as a front end of the first slot part and a rear end of the first slot part, two ends of the second slot part are defined as a front end of the second slot part and a rear end of the second slot part, the front end of the first slot part is connected to the starting end, the rear end of the first slot part is connected to the front end of the second slot part, and the rear end of the second slot part is a tail end; a feed plate, disposed at one side of the starting end of the metal radiation plate, where one end of the feed plate is electrically connected to the metal radiation plate in a bending direction; a connecting grounding plate, disposed at the other side of the starting end of the metal radiation plate, where one end of the connecting grounding plate is electrically connected to the metal radiation plate in the bending direction, and a gap exists between the connecting grounding plate and the feed plate; and a metal grounding plate, disposed under the metal radiation plate, where a spacing area is provided between the metal grounding plate and the metal radiation plate, and the metal grounding plate can be electrically connected to the other end of the connecting grounding plate.

In another embodiment of the present invention, the gap is not greater than 3 times the width of the starting end of the slot.

In another embodiment of the present invention, the feed plate, the connecting grounding plate, and the metal radiation plate are integrated.

In another embodiment of the present invention, the gap is less than or equal to 4.5 mm.

In another embodiment of the present invention, a third slot part is further disposed, where the third slot part is located between the first slot part and the second slot part, two ends of the third slot part are defined as a front end of the third slot part and a rear end of the third slot part, the front end of the third slot part is connected to the rear end of the first slot part, and the rear end of the third slot part is connected to the front end of the second slot part.

In another embodiment of the present invention, a fourth slot part is further disposed, where the fourth slot part is located between the first slot part and the starting end, two ends of the fourth slot part are defined as a front end of the fourth slot part and a rear end of the fourth slot part, the front end of the fourth slot part is connected to the starting end, and the rear end of the fourth slot part is connected to the front end of the first slot part.

In another embodiment of the present invention, a substrate is disposed in the spacing area, where the substrate can be in contact with the metal radiation plate.

In another embodiment of the present invention, the bending direction is an extension direction perpendicular to the metal radiation plate.

In another embodiment of the present invention, the metal radiation plate and the metal grounding plate are parallel.

In another embodiment of the present invention, the metal radiation plate is formed by a process of manufacturing a printed circuit board.

In another embodiment of the present invention, an angle is formed between the rear end of the first slot part and the front end of the second slot part.

### BRIEF DESCRIPTION OF THE DRAWINGS

The disclosure will become more fully understood from the detailed description given herein below for illustration only, and thus are not limitative of the disclosure, and wherein:

FIG. 1 is a schematic structural diagram of an embodiment of an antenna structure according to the present invention;

FIG. 2 is a schematic structural diagram of another embodiment of an antenna structure according to the present invention;

FIG. 3 is a schematic structural diagram of another embodiment of an antenna structure according to the present invention; and

FIG. 4 is a schematic structural diagram of another embodiment of an antenna structure according to the present invention.

### DETAILED DESCRIPTION

The present invention may be fully understood according to the description of the following embodiments, so that a person skilled in the art can implement the present invention according to the description. However, implementation of the present invention is not limited to implementation forms of the following embodiments. Same reference numerals always present same components.

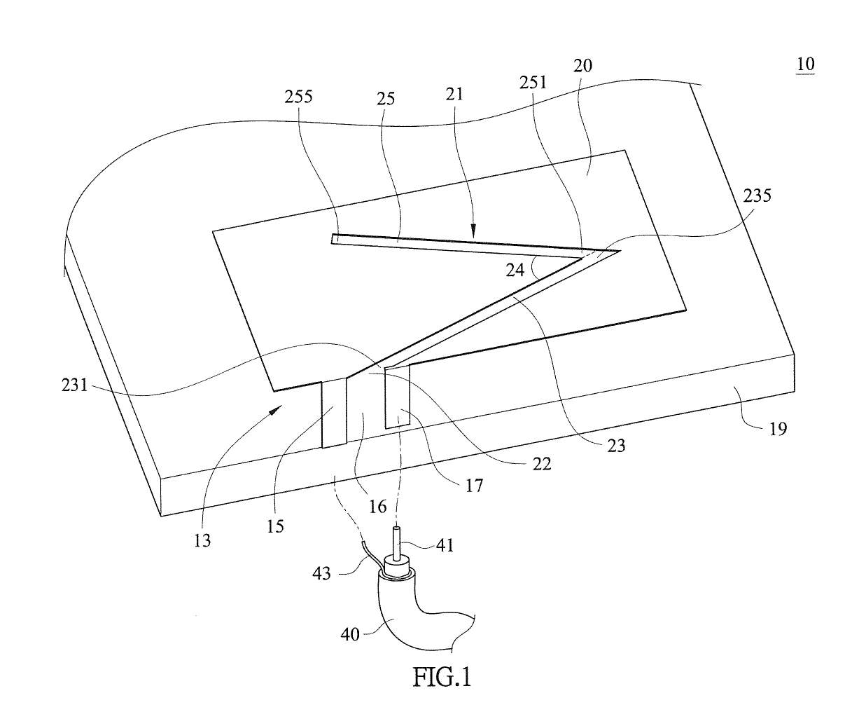

First, referring to FIG. 1, a schematic structural diagram of an embodiment of an antenna structure according to the present invention is shown. As shown in the drawing, an antenna 10 includes a metal radiation plate 20, a slot 21, a connecting grounding plate 15, a feed plate 17, and a metal grounding plate 19.

The metal radiation plate 20 has a slot 21 and a starting end 22, where the starting end 22 is located on an edge of the metal radiation plate 20, the slot 21 extending laterally has a first slot part 23 and a second slot part 25, two ends of the first slot part 23 can be defined as a front end 231 of the first slot part and a rear end 235 of the first slot part, and two ends of the second slot part 25 can be defined as a front end 251 of the second slot part and a rear end 255 of the second slot part. The front end 231 of the first slot part is connected to the starting end 22, the rear end 235 of the first slot part is connected to the front end 251 of the second slot part, and the rear end 255 of the second slot part is a tail end of the slot 21, and an angle 24 is formed between the first slot part 23 and the second slot part 25.

The feed plate 17 is disposed at one side of the starting end 22 of the metal radiation plate 20, where one end of the feed plate 17 is electrically connected to the metal radiation plate 20 in a bending direction. The connecting grounding plate 15 is disposed at the other side of the starting end 22 of the metal radiation plate 20, where one end of the connecting grounding plate 15 is also electrically connected to the metal radiation plate 20 in the bending direction, and a gap 16 exists between the connecting grounding plate 15 and the feed plate 17. The metal grounding plate 19 is disposed under the metal radiation plate 20, where a spacing area 13 exists between the two, the two are not in direct contact, and the metal grounding plate 19 is electrically connected to the other end of the connecting grounding plate 15. In an embodiment of the present invention, the bending direction may be an extension direction perpendicular to the metal radiation plate 20.

In an embodiment of the present invention, the feed plate 17 is electrically connected to a core wire 41 of a coaxial cable 40, and a peripheral conductive layer 43 of the coaxial cable 40 is electrically connected to the metal grounding plate 19, so that a signal generated by the antenna 10 is outputted through the coaxial cable 40.

By adjusting the length of the first slot part 23 and/or the second slot part 25 or the angle 24 between the first slot part 23 and the second slot part 25, multiple resonant modes can be adjusted and controlled, so that the antenna 10 can achieve a broadband effect.

In an embodiment of the present invention, it is preferred that the width of the gap 16 is not greater than 3 times the width of the starting end 22 of the metal radiation plate 20, but the present invention is not limited thereto. The width of the gap 16 is preferably less than or equal to 4.5 mm.

When the antenna 10 of the present invention is applied to a wireless communication product, the metal grounding plate 19 is a full-metal back cover of the wireless communication product. Therefore, a good antenna feature can be maintained without cutting the full-metal back cover. Therefore, the problem of the metal shielding effect in a wireless communication product using a full-metal back cover can be solved, thereby achieving a broadband effect and improved efficiency of an antenna. Besides, the antenna 10 is designed to be disposed in a wireless communication product, and the gap between the metal radiation plate 20 and the metal grounding plate 19 is small. Such a low-profile design can be applied to a thin wireless communication product. Therefore, more freedom is given in terms of product design, which makes it easier to achieve thinness and beauty of a product design.

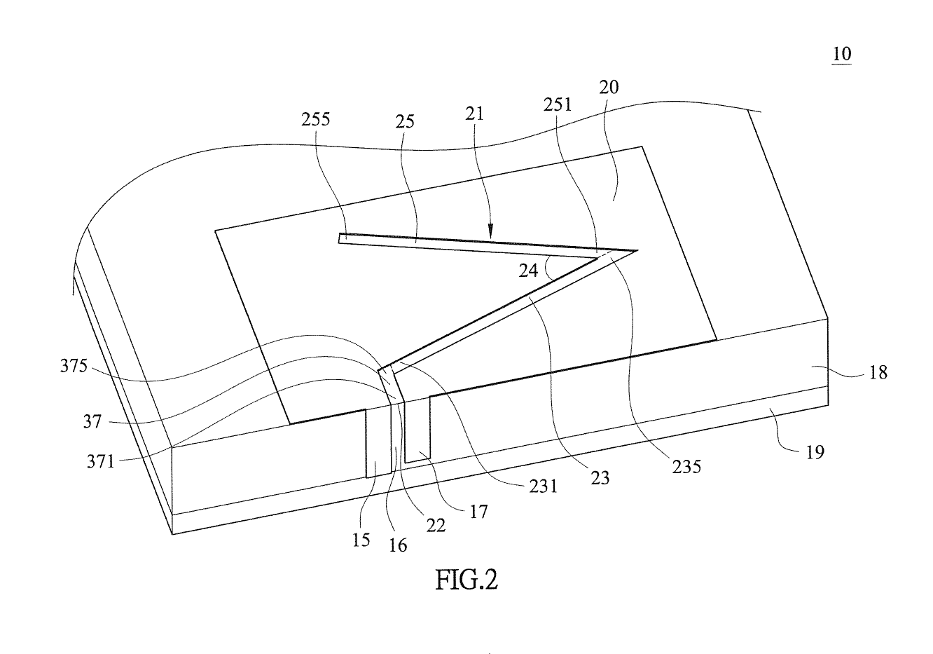

Moreover, referring to FIG. 2, a schematic structural diagram of another embodiment of an antenna structure according to the present invention is shown. The difference between this embodiment and the foregoing embodiment in FIG. 1 lies in that a fourth slot part 37 and a substrate 18 are further disposed in the antenna 10. Two ends of the fourth slot part 37 can be defined as a front end 371 of the fourth slot part and a rear end 375 of the fourth slot part, the front end 371 of the fourth slot part can be connected to the starting end 22 of the metal radiation plate 20, and the rear end 375 of the fourth slot part is connected to the front end 231 of the first slot part. The substrate 18 is disposed between the metal radiation plate 20 and the metal grounding plate 19, and can be used to support the metal radiation plate 20.

By adjusting the length of the first slot part 23, the second slot part 25 and/or the fourth slot part 37 or the angle 24 between the first slot part 23 and the second slot part 25, multiple resonant modes can be adjusted and controlled, so that the antenna 10 can achieve a broadband effect, and the problem of the metal shielding effect in a wireless communication product using a full-metal back cover is solved.

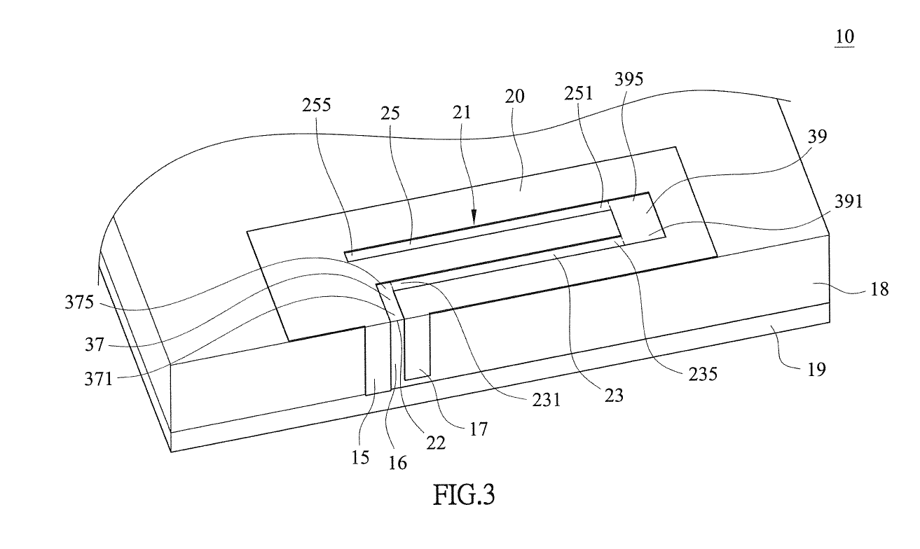

Besides, referring to FIG. 3, a schematic structural diagram of another embodiment of an antenna structure according to the present invention is shown. A difference between this embodiment and the foregoing embodiment in FIG. 1 lies in that the antenna 10 is further provided with a third slot part 39, a fourth slot part 37, and a substrate 18. The third slot part 39 is located between the first slot part 23 and the second slot part 25, and can replace the foregoing angle 24. A front end 371 of the fourth slot part is connected to the starting end 22 of the metal radiation plate 20, and a rear end 375 of the fourth slot part is connected to the front end 231 of the first slot part. Two ends of the third slot part 39 can be defined as a front end 391 of the third slot part and a rear end 395 of the third slot part, the front end 391 of the third slot part is connected to the rear end 235 of the first slot part, the rear end 395 of the third slot part is connected to the front end 251 of the second slot part, and the rear end 255 of the second slot part is a tail end of the slot 21. The substrate 18 is disposed in the spacing area 13 between the metal radiation plate 20 and the metal grounding plate 19, and can be in direct contact with the metal radiation plate 20 and support the metal radiation plate 20.

By adjusting the length of the first slot part 23, the second slot part 25, the third slot part 39 and/or the fourth slot part 37, multiple resonant modes can be adjusted and controlled, so that the antenna 10 can achieve a broadband effect, and the problem of the metal shielding effect in a wireless communication product using a full-metal back cover is solved.

In another embodiment of the present invention, the length of the second slot part 25 is greater than the length of the first slot part 23, so as to form multiple different resonant modes, so that the antenna 10 can achieve a broadband effect.

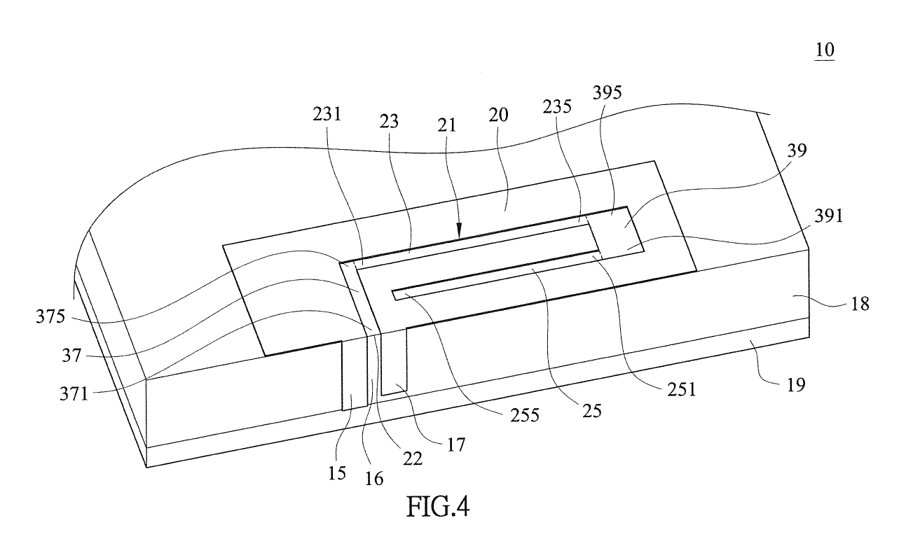

Finally, referring to FIG. 4, a schematic structural diagram of another embodiment of an antenna structure according to the present invention is shown. Differences between this embodiment and the foregoing embodiment in FIG. 3 lie in different manners for connecting the third slot part 39 to the first slot part 23 and the second slot part 25. In this embodiment, the rear end 395 of the third slot part is connected to the rear end 235 of the first slot part, and the front end 391 of the third slot part is connected to the front end 251 of the second slot part. Therefore, the shape of the slot 21 differs from that in the embodiment in FIG. 3.

By adjusting the length of the first slot part 23, the second slot part 25, the third slot part 39 and/or the fourth slot part 37, multiple resonant modes can be adjusted and controlled, so that the antenna 10 can achieve a broadband effect, and the problem of the metal shielding effect in a wireless communication product using a full-metal back cover is solved.

Still, in another embodiment of the present invention, the second slot part 25 and the first slot part 23 are approximately parallel.

In another embodiment of the present invention, the length of the first slot part 23 is greater than the length of the second slot part 25, so as to form multiple different resonant modes, so that the antenna 10 can achieve a broadband effect.

In another embodiment of the present invention, the metal radiation plate 20, the connecting grounding plate 15, and the feed plate 17 are integrated, so that when the antenna structure of the present invention is manufactured, the metal radiation plate 20, the connecting grounding plate 15, and the feed plate 17 can be cut from a same piece of metal, and then the connecting grounding plate 15 and the feed plate 17 are formed through bending, which makes the manufacturing procedure quicker and more efficient and ensures electrical connections.

In another embodiment of the present invention, the metal radiation plate 20 of the antenna 10 can be manufactured by the process of manufacturing a related circuit such as a printed circuit board.

According to the foregoing descriptions, the present invention is an invention that is of industrial applicability and novelty and has great value for the development of industrial technologies. The foregoing descriptions are merely embodiments of the present invention, and do not limit the implementation scope of the present invention. All equivalent alterations and modifications made according to the patent application scope of the present invention fall within the patent scope of the present invention.

### DESCRIPTION OF NUMERALS

10 Antenna
13 Spacing area
15 Connecting grounding plate
16 Gap
17 Feed plate
18 Substrate
19 Metal grounding plate
20 Metal radiation plate
21 Slot
22 Starting end
23 First slot part
231 Front end of the first slot part
235 Rear end of the first slot part
24 Angle
25 Second slot part
251 Front end of the second slot part
255 Rear end of the second slot part
37 Fourth slot part
371 Front end of the fourth slot part
375 Rear end of the fourth slot part
39 Third slot part
391 Front end of the third slot part
395 Rear end of the third slot part
40 Coaxial cable
41 Core wire
43 Peripheral conductive layer

What is claimed is:

1. An antenna structure, comprising:
a metal radiation plate, having a slot and a starting end, wherein the starting end is located on an edge of the metal radiation plate, the slot extending laterally has a first slot part and a second slot part, two ends of the first slot part are defined as a front end of the first slot part and a rear end of the first slot part, two ends of the second slot part are defined as a front end of the second slot part and a rear end of the second slot part, the front end of the first slot part is connected to the starting end, the rear end of the first slot part is connected to the front end of the second slot part, and the rear end of the second slot part is a tail end;
a feed plate, disposed at one side of the starting end of the metal radiation plate, wherein one end of the feed plate is electrically connected to the metal radiation plate in a bending direction;
a connecting grounding plate, disposed at the other side of the starting end of the metal radiation plate, wherein one end of the connecting grounding plate is electrically connected to the metal radiation plate in the bending direction, and a gap exists between the connecting grounding plate and the feed plate; and
a metal grounding plate, disposed under the metal radiation plate, wherein a spacing area is provided between the metal grounding plate and the metal radiation plate, and the metal grounding plate can be electrically connected to the other end of the connecting grounding plate.

2. The antenna structure according to claim 1, wherein the gap is not greater than 3 times the width of the starting end of the slot.

3. The antenna structure according to claim 1, wherein the feed plate, the connecting grounding plate, and the metal radiation plate are integrated.

4. The antenna structure according to claim 1, wherein the gap is less than or equal to 4.5 mm.

5. The antenna structure according to claim 1, wherein a third slot part is further disposed, the third slot part is located between the first slot part and the second slot part, two ends of the third slot part are defined as a front end of the third slot part and a rear end of the third slot part, the front end of the third slot part is connected to the rear end of the first slot part, and the rear end of the third slot part is connected to the front end of the second slot part.

6. The antenna structure according to claim 1, wherein a fourth slot part is further disposed, the fourth slot part is located between the first slot part and the starting end, two ends of the fourth slot part are defined as a front end of the fourth slot part and a rear end of the fourth slot part, the front end of the fourth slot part is connected to the starting end, and the rear end of the fourth slot part is connected to the front end of the first slot part.

7. The antenna structure according to claim 1, wherein a substrate is disposed in the spacing area, and the substrate can be connected to the metal radiation plate.

8. The antenna structure according to claim 1, wherein the bending direction is an extension direction perpendicular to the metal radiation plate.

9. The antenna structure according to claim 1, wherein the metal radiation plate and the metal grounding plate are parallel.

10. The antenna structure according to claim 1, wherein the metal radiation plate is formed by a process of manufacturing a printed circuit board.

11. The antenna structure according to claim 1, wherein an angle is formed between the rear end of the first slot part and the front end of the second slot part.
